(19) United States
(12) Patent Application Publication
(10) Pub. No.: US 2013/0216719 A1
(43) Pub. Date: Aug. 22, 2013

(54) METHOD AND SYSTEM FOR COATING SUBSTRATES

(71) Applicants: Manish Doshi, Surat (IN); Ronak Choksi, Surat (IN); Prakash Sojitra, Surat (IN)

(72) Inventors: Manish Doshi, Surat (IN); Ronak Choksi, Surat (IN); Prakash Sojitra, Surat (IN)

(73) Assignee: ENVISION SCIENTIFIC PRIVATE LIMITED, Surat (Gujarat) (IN)

(21) Appl. No.: 13/881,983

(22) PCT Filed: Oct. 25, 2011
(86) PCT No.: PCT/IN11/00741

§ 371 Date: Apr. 26, 2013

(30) Foreign Application Priority Data
Oct. 27, 2010 (IN) 2986/MUM/2010

(51) Int. Cl. B05D 1/26; B05C 3/02

(52) U.S. Cl. CPC B05D 1/26; B05C 3/02
USPC 427/430.1; 118/429

(57) ABSTRACT

The invention provides a method and apparatus for coating a substrate. The apparatus includes one or more enclosures positioned at an angle relative to a plane. Each enclosure is capable of receiving one or more substrates. The one or more enclosures include one or more inlets for receiving a coating fluid. The coating fluid flows in a pre-defined direction to coat the one or more substrates with the coating fluid. The one or more enclosures are positioned at the angle relative to the plane by one or more supporting structures and are dynamically adjustable to enable the flow of coating fluid in pre-defined direction.

### FIELD OF THE INVENTION

The invention generally relates to coating substrates. More specifically, the invention relates to a method and apparatus for coating a substrate with a coating fluid.

### BACKGROUND OF THE INVENTION

Substrates include a balloon, a stent, a stent-balloon, a catheter, a graft, an implantable medical device and an insertable medical device. The substrates keep a blood vessel or a body lumen expanded when inserted inside a body lumen. The substrates are coated with a coating fluid to deliver drugs or other therapeutic agents inside the body lumen. The coating fluid includes a drug, a therapeutic agent, a nano-carrier along with a polymer, and a biological agent. The substrate may be coated by a method of, spray coating and immersion coating.

Immersion coating is a well-known technique for coating substrates. In immersion coating, a substrate is coated by immersing the substrate vertically in a coating fluid. Subsequently, the substrate is removed from the coating fluid along a vertical direction and dried. However, when the substrate is immersed in and subsequently withdrawn from the coating fluid along a vertical direction, the coating fluid on the substrate is subjected to gravitational force. This leads to dripping of the coating fluid from a top portion of the substrate to a bottom portion of the substrate. Thus, the uniformity with which the coating fluid is coated on the substrate is affected. In other words, thickness of a coating layer thus formed on the surface of the substrate may be non-uniform.

Therefore, there is a need in the art for a method and system for an improved method for coating of substrates.

### BRIEF DESCRIPTION OF THE FIGURES

The accompanying figures where like reference numerals refer to identical or functionally similar elements throughout the separate views and which together with the description below are incorporated in and form part of the specification, serve to further illustrate various embodiments and to explain various principles and advantages all in accordance with the invention.

FIG. 1 illustrates a schematic diagram of an enclosure for coating a substrate in accordance with an embodiment of the invention.

FIG. 2 illustrates a schematic diagram of an apparatus for coating a substrate in accordance with another embodiment of the invention.

FIG. 3 illustrates a flow chart of a method for coating a substrate in accordance with an embodiment of the invention.

FIG. 4 illustrates a flow chart of a method for coating a substrate in accordance with another embodiment of the invention.

### DETAILED DESCRIPTION OF THE INVENTION

Before describing in detail embodiments that are in accordance with the invention, it should be observed that the embodiments reside primarily in a method and apparatus for coating substrates. Accordingly, the apparatus components and the method steps have been described to include only those specific details that are pertinent to understanding the embodiments of the invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, or apparatus that comprises a list of elements does not include only those elements but may include other elements not expressly listed or inherent to such process, method or apparatus. An element preceded by “comprises . . . a” does not, without more constraints, preclude the existence of additional identical elements in the process, method or apparatus that comprises the element.

Further, before describing in detail embodiments that are in accordance with the invention, it should be observed that all the scientific and technical terms used in for describing the invention have same meanings as would be understood by a person skilled in the art.

Various embodiments of the invention provide an apparatus for coating a substrate. The apparatus includes one or more enclosures positioned at an angle relative to a plane. Each enclosure of the one or more enclosures is capable of receiving one or more substrates. The one or more enclosures include one or more inlets for receiving a coating fluid. The coating fluid flows in a pre-defined direction to coat the one or more substrates with the coating fluid. The one or more enclosures are positioned at the angle relative to the plane by one or more supporting structures.

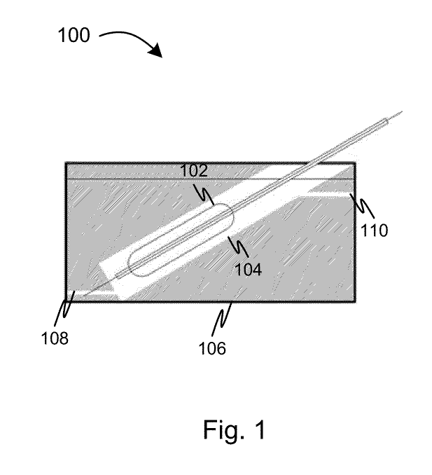

FIG. 1 illustrates a schematic diagram of an apparatus 100 for coating one or more substrates such as, substrate 102 in accordance with an embodiment. Apparatus 100 includes one or more enclosures, such as an enclosure 104 positioned at an angle relative to a plane such as, a horizontal plane. The angle of positioning enclosure 104 ranges from 0° to 90°. However, the one or more enclosures may be positioned in any other angle with respect to the plane for conveniently coating the one or more substrates with the coating fluid. In an embodiment, enclosure 104 may be positioned at an angle relative to the plane using one or more supporting structures such as, supporting structure 106. Examples of a supporting structure may include but are not limited to, a stand, a box structure, a shell structure, a frame structure, a structure with a mechanical agitator inside a vessel and a holder or a multiple holder. The angle of positioning the one or more enclosures may be adjusted dynamically to a level. The angle of position of the one or more enclosures may be altered or adjusted using a belt mechanism or any mechanism known in the art.

For example if the supporting structure is a box structure, an enclosure may be configured within the box structure at an angle. In this case, the enclosure may be an integral part of the box structure. Alternatively, the enclosure may be a separate element positioned within the box structure. In another scenario, the supporting structure may be a solid structure having one or more enclosures capable of receiving one or more substrates. The one or more enclosures are part of the solid structure and may be configured at any angle. In this case, an enclosure may be a hollow channel configured within the supporting structure.

For example if the supporting structure is a shell structure, an enclosure may be positioned within the shell structure at an angle. In this case, the enclosure may be a separate unit enclosed within the shell structure. Alternatively, the enclosure may be an integral element attached to the shell structure. In another scenario, the supporting structure may be a member based frame structure having one or more members interconnected with each other creating a frame. The frame structure includes one or more enclosures capable of receiving one or more substrates. The one or more enclosures are part of the frame structure and may be configured at any angle. In this case, an enclosure may be a separate hollow channel interconnected within the frame structure.

Now in an embodiment where the supporting structure is a stand, the stand may be adjustable to change the angle of alignment or position of the one or more enclosures supported by the stand. The stand may have an angle adjusting mechanism known in the art for adjusting the angle of the enclosure thereby adjusting the angle of position of the one or more substrates to be coated. Further, the one or more enclosures such as, enclosure 104 may have a cross-section of any shape. The shape may be for example but are not limited to, circular, rectangular, polygonal, cylindrical, trapezoidal and oval.

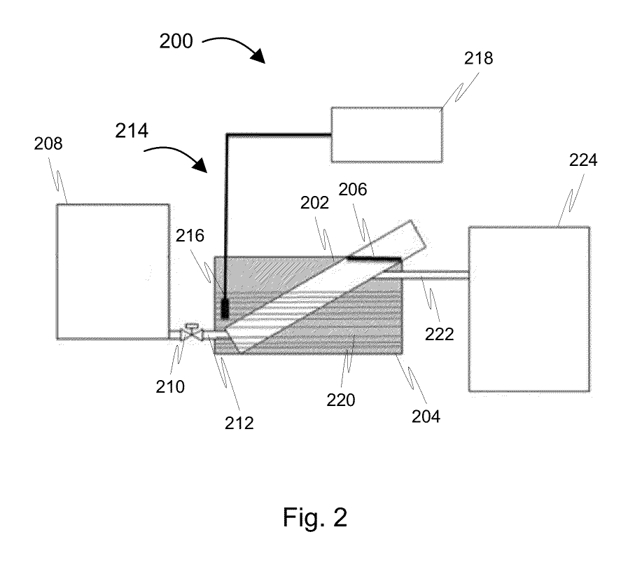

In an embodiment, the one or more enclosures such as, enclosure 104 receives the one or more substrates such as, substrate 102. Examples of substrate 102 may include, but are not limited to, a balloon, a stent, a stent-balloon, a catheter, a graft, an implantable medical device and an insertable medical device. The one or more enclosures may include one or more inlets such as, inlet 108 of enclosure 104 for receiving a coating fluid for coating substrate 102. Receiving the coating fluid through one or more inlets is further explained in conjunction with FIG. 2.

The coating fluid is composed of one or more low boiling point solvents and one or more drug particles. Examples of the one or more low boiling point solvents may include, but are not limited to, methanol, ethanol, iso-propyl alcohol, trichloromethane, tetrachloromethane, tetrachloroethane, trichloroethane, Dimethyl sulfoxide (DMSO), tetrahydrofuran, dichloromethane, chloroform, n-propanol, dimethylformamide, dimethylacetamide. In some embodiments, the one or more solvents include alcohols (e.g., methanol, ethanol, 1,3-propanol, 1,4-butanol), heptane, hexane, pentane, cyclohexanone, trichloroethane, acetone, tetrahydrofuran (THF), dimethyl acetamide (DMAc), dioxane, toluene, xylene, dimethyl sulfoxide (DMSO), dimethyl formamide (DMF), ethyl acetate, methyl ethyl ketone (MEK), and acetonitrile. 1-methyl-2-pyrrolidinone (NMP).

Examples of the one or more drug particles may include, but are not limited to, sirolimus, tacrolimus, paclitaxel, Novolimus, myolimus, clobetasol, dexamethasone, genistein, heparin, beta-estadiol, rapamycin, everolimus, ethylrapamycin, zotarolimus, ABT-578, Biolimus A9, docetaxel, methotrexate, azathioprine, vincristine, vinblastine, fluorouracil, doxorubicin hydrochloride, mitomycin, sodium heparin, a low molecular weight heparin, a heparinoid, hirudin, argatroban, forskolin, vapiprost, prostacyclin, a prostacyclin analogue, dextran, D-phe-pro-arg-chloromethylketone, dipyridamole, glycoprotein IIb/IIIa, recombinant hirudin, bivalirudin, nifedipine, colchicines, lovastatin, nitroprusside, suramin, a serotonin blocker, a steroid, a thioprotease inhibitor, triazolopyrimidine, a nitric oxide or nitric oxide donor, a super oxide dismutase, a super oxide dismutase mimetic, estradiol, aspirin, angiopeptin, captopril, cilazapril, lisinopril, permirolast potassium, alpha-interferon, bioactive RGD and any salts or analogues thereof.

The coating fluid flows in a pre-defined direction within enclosure 104 to coat substrate 102 with the coating fluid. The pre-defined direction of flow of the coating fluid is one of an upward direction and a downward direction. As illustrated in FIG. 1, inlet 108 is located in a bottom portion of apparatus 100, thus the coating fluid will flow in an upward direction from a bottom part to an upper part of enclosure 104. In this case, substrate 102 is coated with the coating fluid from a bottom portion of substrate 102 to an upper portion of substrate 102. In a scenario, the one or more inlets may be located in any other part of apparatus 100 to enable the coating fluid to flow in a downward direction from the upper part to the bottom part of enclosure 104. When the coating fluid flows within enclosure 104, the temperature of the coating fluid needs to be controlled. Controlling the temperature of the coating fluid is critical as the coating fluid is composed of low boiling point solvents. To this end, a temperature-regulating unit (not shown in FIG. 1) is provided to regulate the temperature of the coating fluid. The temperature-regulating unit is explained in detail in conjunction with FIG. 2.

To coat substrate 102 with the coating fluid, in an embodiment substrate 102 immersed in the coating fluid is rotated within enclosure 104. Substrate 102 may be rotated with respect to an axis of enclosure 104. In an embodiment, substrate 102 may be coated with the coating fluid using one or more spray nozzles present in enclosure 104. The one or more spray nozzles may be positioned within enclosure 104. More specifically the one or more spray nozzles may be configured within walls of the one or more enclosures such as, enclosure 104 and may have their nozzle ends configured at different locations on an inner wall (not shown in FIG. 1) of enclosure 104. The one or more spray nozzles receive the coating fluid through inlet 108. In another embodiment, the one or more spray nozzles may receive the coating fluid from a storage tank holding the coating fluid (not shown in FIG. 1). The storage tank may be present in apparatus 100. Subsequently substrate 102 may be removed from enclosure 104 by an up and down movement within enclosure 104. While removing substrate 102, substrate 102 may be rotated. Alternatively, substrate 102 may not be rotated while removing substrate 102 at a predefined speed. The predefined speed at which substrate 102 is removed may be determined based on a thickness of a coating layer that is required for substrate 102. Removal of substrate 102 at the pre-defined speed prevents dripping of the coating fluid from substrate 102 thereby improving uniformity of the coating layer formed on substrate 102. Once substrate 102 is removed from enclosure 104, substrate 102 is dried.

In an alternative embodiment, substrate 102 removed from enclosure 104 may be coated with another coating fluid using a spray unit and subsequently substrate 102 is dried. In case the coating fluid is composed of the one or more solvents and the one or more drug particles, drying of substrate 102 results in evaporation of the one or more solvents to provide a layer of the one or more drug particles on substrate 102. In an embodiment, substrate 102 may be dried using a dryer. However, any suitable drying system known in the art may be employed for drying substrate 102. The dryer may be configured to dry substrate 102 at a predefined temperature. The predefined temperature may be set in the dryer by a person coating substrate 102 with the coating fluid or operating apparatus 100. The predefined temperature may be set based on a drying temperature associated with substrate 102. In an embodiment, a dryer may be present in apparatus 100 for drying substrate 102. Apparatus 100 in this case may include a temperature setting unit for setting the temperature of the dryer. Substrate 102 may be dried within enclosure 104 and subsequently removed. The excess coating fluid in enclosure 104 left after coating substrate 102 is removed through one or more outlets, such as outlet 110 in the enclosure.

FIG. 2 illustrates a schematic diagram of an apparatus 200 for coating a substrate (not shown in FIG. 2) in accordance with an embodiment. Apparatus 200 includes one or more enclosures, such as an enclosure 202 positioned at an angle relative to the horizontal plane by one or more supporting structures, such as a supporting structure 204. Enclosure 202 is positioned at an angle relative to the horizontal plane by one or more supporting structures such as, supporting structure 204. The angle of positioning enclosure 202 may be adjusted dynamically. Examples of the supporting structure may include but are not limited to, a stand, a box structure, a holder. The supporting structure is explained in detail in conjunction with FIG. 1. Enclosure 202 includes an opening (i.e. hole) covered by a lid such as a lid 206. Lid 206 may have a hole (not shown in FIG. 2) with a predefined dimension allowing the substrate such as, substrate 102 to pass through and be placed within enclosure 202. A seal is configured in the hole of lid 206 to prevent overflow of the coating fluid from the enclosure. In another scenario, lid 206 may be opened and the substrate may be allowed to pass through enclosure 202. A closing mechanism may be used for closing lid 206 once the substrate is placed in enclosure 202. The closing mechanism may be a spring based, a hydraulic based, a gravity based mechanism, or may be based on any closing mechanisms known in the art. Further, the closing mechanism may be configured to open on application of force on lid 206. Alternatively, enclosure 202 may not have a lid and will be open at the top.

Enclosure 202 includes one or more inlets that allow the coating fluid to flow into enclosure 202. The coating fluid while entering enclosure 202 flows in a pre-defined direction to coat the substrate. The pre-defined direction may be one of an upward direction and a downward direction along enclosure 202. This is explained in detail in conjunction with FIG. 1. The coating fluid may be supplied by one or more supply units. Alternatively, a single supply unit may be connected to the one or more enclosures such as, enclosure 202 through the one or more inlets. For example, supply unit 208 holding the coating fluid may be connected to enclosure 202 using the one or more inlet pipes, such as an inlet pipe 210. The coating fluid is then supplied to enclosure 202. The flow of the coating fluid through inlet pipe 210 is regulated using one or more valves, such as a valve 212. The flow of the coating fluid may vary due to properties of the coating fluid. Examples of properties of the coating fluid include viscosity and low boiling points. In an embodiment, one or more supply units may include pressure valves to obtain a desired flow rate of the coating fluid.

In another embodiment, the one or more supply units may hold one or more coating fluids and may be connected to an enclosure such as, enclosure 202. Alternatively, a single supply unit may be provided for holding the one or more coating fluids. In such a case, the supply unit may have one or more compartments for holding the one or more coating fluids. The one or more coating fluids may flow into the enclosure through the one or more inlet pipes connecting the one or more supply units to the enclosure. The flow rate of the one or more coating fluids passing through the one or more inlet pipes may be regulated using the one or more valves present in the one or more inlet pipes. In an embodiment, a first coating fluid may be supplied at a flow rate to enclosure 202 by the one or more valves. Further, a second coating fluid may be supplied at a different flow rate to enclosure 202 after supplying the first coating fluid. In this case, the flow rate of the first coating fluid may be greater than the flow rate of the second coating fluid. In another embodiment, the first coating fluid may have a density different from the second coating fluid. In this case, the one or more control valves may be operated to allow the first coating fluid and the second coating fluid to flow through the one or more inlet pipes into the enclosure at the same flow rate or different flow rates. In this embodiment of supplying two coating fluids, the substrate may be coated with the first coating fluid initially and thereafter coated with the second coating fluid.

The temperature of the coating fluid supplied to enclosure 202 needs to be regulated or controlled using a temperature regulating unit. In an embodiment, a temperature regulating unit, such as temperature regulating unit 214 may be used to regulate or control the temperature of the coating fluid. Temperature regulating unit 214 includes a temperature sensor 216, a temperature indicator 218 and a temperature regulator, such as a coil 220. Temperature sensor 216 measures the temperature of the coating fluid present inside enclosure 202. Temperature indicator 218 displays the measured temperature of the coating fluid. Then the person coating the substrate with the coating fluid may modify a temperature set if the temperature of the coating fluid is not within the permitted limits. Based on the temperature set, coil 220 controls or modifies the temperature of the coating fluid. In an embodiment, it may be determined that the temperature of the coating fluid may be above a predefined threshold temperature. In such a case, coil 220 controls the temperature of the coating fluid in a manner such that the temperature is maintained above the predefined threshold. When the temperature of the coating fluid falls below the predefined threshold then coil 220 increases the temperature of the coating fluid. A thermostat unit or any other temperature controlling unit known in the art may be used for operating coil 220. Thus, by controlling the temperature of the coating fluid uniform coating of the substrate is achieved. Alternatively, coil 220 may be coiled around enclosure 202. Coil 220 controls the temperature of the coating fluid present in enclosure 202.

Once the coating fluid is coated on the substrate, a dryer may used to dry the substrate. Now referring back to the embodiment having two coating fluids, once the first coating fluid is coated on a substrate, the dryer may be used to dry the substrate. The dryer may be present in apparatus 200. The dryer may include one or more blowers for blowing air for drying the substrate. In this scenario, the one or more blowers may be positioned near to the enclosure such as, enclosure 202 for drying the substrate. Thereafter, the second coating fluid may be coated on the substrate and the substrate is dried using the one or more blowers. This may be repeated for any number of additional coating fluids that may be required to form multiple layers of coating fluids on the substrate.

After coating the substrate with the coating fluid some excess coating fluid may be remaining in enclosure 202. Apparatus 200 includes one or more outlets connected to enclosure 202 for removing this excess coating fluid. One or more outlet pipes, such as outlet pipe 222 is connected to the one or more outlets of apparatus 200 to facilitate removal of the excess coating fluid from enclosure 202. Outlet pipe 222 includes one or more valves to facilitate the flow of the excess coating fluid flowing from enclosure 202. The excess coating fluid may also be removed from enclosure 202 by any method known in the art. Outlet pipe 222 may be connected to a reservoir 224 capable of collecting the excess coating fluid. In an embodiment, the excess coating fluids may be collected in one or more reservoirs. Alternatively, a single reservoir may be used to collect the coating fluid from one or more enclosures such as, enclosure 202. Further, a reservoir may be provided with one or more compartments to hold the one or more excess coating fluids. In an embodiment, the one or more excess coating fluids collected in the reservoir may be supplied to a supply unit such as, supply unit 208 to recirculate the one or more coating fluids. The reservoir may supply the one or more excess coating fluids to the supply unit using one or more pipes and valves connecting the reservoir and the supply unit.

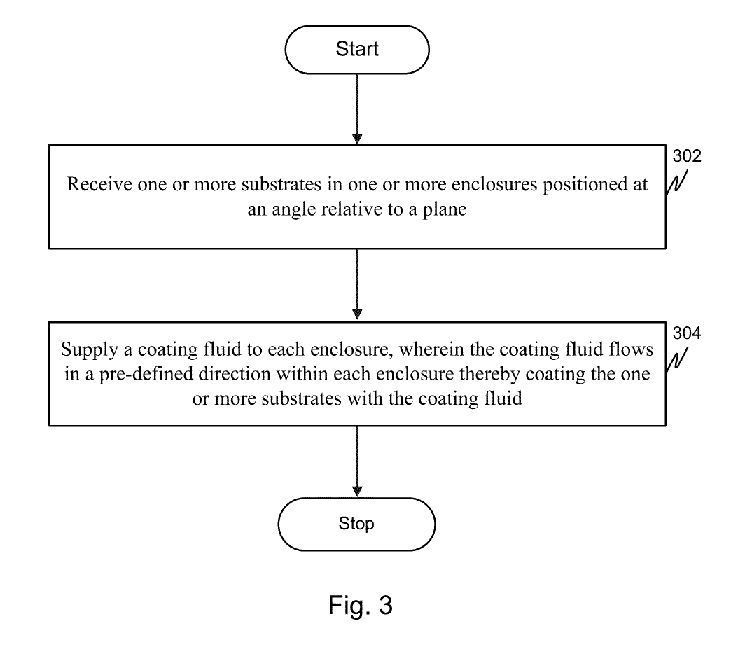

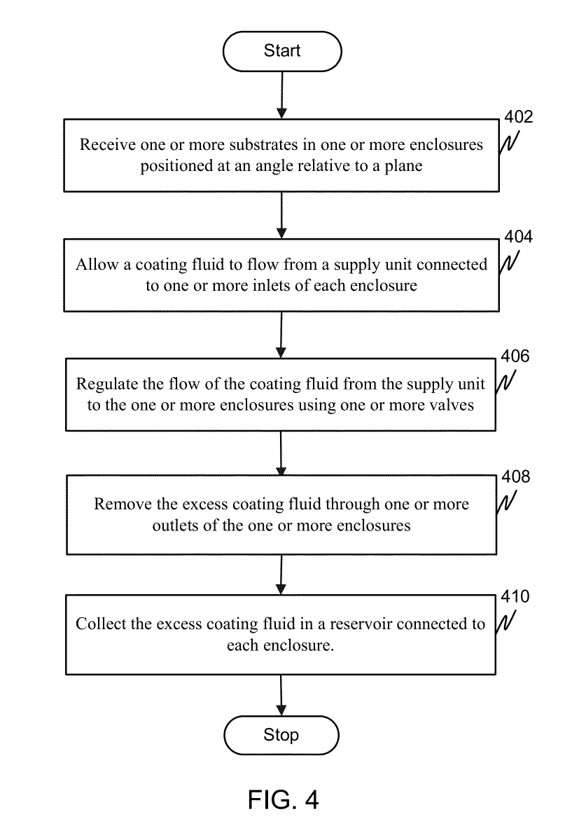

FIG. 3 illustrates a flow chart of a method for coating a substrate in accordance with an embodiment of the invention. At step 302, one or more substrates are received within one or more enclosures of an apparatus. The one or more enclosures are positioned at an angle relative to a plane such as, a horizontal plane. Examples of the one or more substrates may include, but are not limited to, a balloon, a stent, a stent-balloon, a catheter, a graft, an implantable medical device and an insertable medical device. A substrate of the one or more substrates with any geometry may be received within an enclosure. Thus, the enclosure may have any geometry for receiving a substrate of matching geometry. Each enclosure of the one or more enclosures includes one or more inlets for receiving a coating fluid. The coating fluid is composed of one or more low boiling point solvents and one or more drug particles. The coating fluid is supplied to the one or more enclosures at step 304. Receiving the coating fluid through the one or more inlets of the apparatus such as, apparatus 100 and apparatus 200 is explained in detail in conjunction with FIG. 2. The coating fluid flows in a pre-defined direction within the one or more enclosures, thereby coating the one or more substrates with the coating fluid. The pre-defined direction of flow of the coating fluid is one of an upward direction and a downward direction along the one or more enclosures. The method of flowing of the coating fluid to coat the one or more substrates is explained further in detail in conjunction with FIG. 4.

FIG. 4 illustrates a flow chart of a method for coating a substrate in accordance with an embodiment of the invention. At step 402, one or more substrates are received in one or more enclosures positioned at an angle relative to a plane such as, a horizontal plane. The one or more enclosures include one or more inlets for receiving a coating fluid. A supply unit connected to one or more inlets of an enclosure of the one or more enclosures holds the coating fluid. The coating fluid flows through the one or more inlet pipes from the supply unit connected to one or more inlets of the enclosure at step 404. The flow rate of the coating fluid flowing from the supply unit to the one or more enclosures is regulated using one or more valves at step 406. The one or more valves may be configured on the one or more inlet pipes. These one or more valves may be operated to regulate the flow of the coating fluid.

The coating fluid flows in a pre-defined direction within the one or more enclosures thereby coating the substrate with the coating fluid. The pre-defined direction of flow of the coating fluid is one of an upward direction and a downward direction along the one or more enclosures. The substrate may be rotated with respect to an axis of the enclosure when the coating fluid flows in the upward and downward direction. As result, the coating fluid is coated on the substrate. Subsequently, the substrate is removed from the enclosure after an up and down movement. While removing the substrate from the enclosure the substrate may be rotated. Alternatively, the substrate may not be rotated when the substrate is removed at a predefined speed. The predefined speed at which the substrate is removed may be determined based on a thickness of the coating layer that is required for the substrate. Removal of the substrate at the pre-defined speed facilitates in improving the uniformity of a coating layer formed on the substrate as it prevents dripping of the coating fluid.

Once the substrate is removed from the enclosure, the substrate is dried. In case the coating fluid is composed of the one or more solvents and the one or more drug particles, drying of the substrate results in evaporation of the one or more solvents to provide a layer of the one or more drug particles on the substrate. In an embodiment, the substrate 102 may be dried using a dryer. This is explained in detail in conjunction with FIG. 1. At step 408, the excess coating fluid left in the enclosure is removed through one or more outlets of the enclosure. The excess coating fluid may be the coating fluid left over in the enclosure after coating the substrate. The excess coating fluid is then collected in a reservoir connected to the enclosure at step 410. The excess coating fluid may be then circulated back to the supply unit so that the coating fluid can be used for coating any other substrate. The process of circulating the coating fluid to the reservoir is explained in detail in conjunction with FIG. 2.

In an exemplary embodiment, a substrate such as, Yangtze μ PTCA catheter was received in an enclosure positioned at an angle of 45 degree relative to a horizontal plane. A coating fluid present in a supply unit was allowed to flow into the enclosure through one or more inlet pipes. The flow rate of the coating fluid flowing from the supply unit in to the enclosure was regulated using one or more valves. The flow rate was maintained at a range of 1 ml/min to 5 ml/min. The coating fluid was then allowed to flow in an upward direction and a downward direction along the enclosure to coat the substrate. The process of coating was done for a duration of two minutes. Thereafter the substrate was removed with an up and down movement along an axis of the enclosure. The up down movement ranges from 10 to 50 movement/minute. The substrate was also rotated about the axis while removing from the enclosure. The speed of rotation ranges from 10 rpm to 50 rpm. While coating the substrate, the temperature of the coating fluid was maintained between 10° C. to 45° C. by a temperature-regulating unit. Thereafter, the substrate was dried in a vacuum chamber for example, a metalab vacume oven for 10 minutes at 40° C. The coating process followed by drying of the substrate was repeated twice. Further, excess coating fluid was removed through one or more outlets of the enclosures. The excess coating fluid removed through the one or more outlets is collected in a reservoir connected to the enclosure.

The coating fluid used here was prepared by mixing solution A and solution B. Solution A was prepared by dissolving 0.5 gm lipoid E80 in 25 ml of acetone. Thereafter, solution A was stored in an air-tight amber colored Standard Measuring Flask (SMF). Solution B was prepared by dissolving 0.5 gm of paclitaxel in 25 ml of acetone. Thereafter, solution B was stored in an air-tight amber colored Standard Measuring Flask (SMF). Solution A and solution B were mixed drop by drop to form the coating fluid. The coating fluid was stored under refrigeration in an air-tight amber colored SMF.

Thus, the method and system for coating a substrate provides a coating layer of uniform thickness and reduces dripping of a coating fluid from a top portion of the substrate to a bottom portion of the substrate. The dripping of the coating fluid is reduced due to positioning of the substrate at a predefined angle. The rate of flow of the coating fluid and the temperature of the coating fluid is controlled to obtain a specific thickness of coating fluid on the substrate. The speed at which the substrate is removed from an enclosure further ensures a uniform thickness of coating layer on the substrate. The substrate may have one or more coating layers with uniform thickness, wherein the one or more coating layers correspond to one or more coating fluids. Further, a substrate with any geometry may be coated with the coating fluid. Additionally, the method and system dries the substrate within the enclosure thereby completing the entire process of coating the substrate under sterile conditions.

Those skilled in the art will realize that the above-recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes may be made to the invention without deviating from the scope of the invention. Accordingly, the specification is to be regarded in an illustrative rather than a restrictive sense, and all such modifications are intended to be included within the scope of the invention.

What is claimed is:

1. An apparatus for coating substrates, the apparatus comprising:
at least one enclosure positioned at an angle relative to a plane, each enclosure being capable of receiving at least one substrate, wherein each enclosure comprises:
at least one inlet for receiving a coating fluid, wherein the coating fluid flows in a pre-defined direction to coat the at least one substrate with the coating fluid; and
at least one supporting structure for positioning the at least one enclosure at the angle relative to the plane.

2. The apparatus of claim 1, wherein the angle ranges from 0° to 90°.

3. The apparatus of claim 1, wherein the angle for positioning the at least one enclosure is dynamically adjusted.

4. The apparatus of claim 1, wherein the pre-defined direction to coat the at least one substrate with the coating fluid is one of an upward direction along the at least one enclosure and a downward direction along the at least one enclosure.

5. The apparatus of claim 1, wherein the at least one substrate comprises at least one of a balloon, a stent, a stent-balloon, a catheter, a graft, an implantable medical device and an insertable medical device.

6. The apparatus of claim 1 further comprising a temperature regulating unit for regulating temperature associated with the coating fluid.

7. The apparatus of claim 1 further comprising a supply unit connected to the at least one inlet of each enclosure, wherein the supply unit is capable of holding the coating fluid and supplying the coating fluid to each enclosure.

8. The apparatus of claim 1 further comprising at least one inlet pipe connecting the supply unit and each enclosure to supply the coating fluid.

9. The apparatus of claim 8 further comprising at least one valve for regulating flow of the coating fluid flowing through the at least one inlet pipe.

10. The apparatus of claim 1, wherein each enclosure comprises at least one outlet to enable excess coating fluid to flow out from each enclosure.

11. The apparatus of claim 10 further comprising at least one outlet pipe connecting the at least one outlet to each enclosure to collect excess coating fluid.

12. The apparatus of claim 10 further comprising at least one valve for facilitating flow of the excess coating fluid from each enclosure.

13. The apparatus of claim 12 further comprising a reservoir connected to the at least one outlet pipe, wherein the reservoir is capable of collecting the excess coating fluid.

14. The apparatus of claim 1 further comprising a lid for covering an enclosure of the at least one enclosure.

15. The apparatus of claim 14, wherein the lid comprises:
a hole with a predefined diameter; and
a seal configured in the hole to prevent overflow of the coating fluid.

16. A method for coating substrates, the method comprising:
receiving at least one substrate in at least one enclosure positioned at an angle relative to a plane; and
supplying a coating fluid to each enclosure of the at least one enclosure, wherein the coating fluid flows in a pre-defined direction within each enclosure thereby coating the at least one substrate with the coating fluid.

17. The method of claim 16, wherein the pre-defined direction to coat the at least one substrate with the coating fluid is one of an upward direction along the at least one enclosure and a downward direction along the at least one enclosure.

18. The method of claim 16, wherein supplying the coating fluid comprises allowing the coating fluid to flow from a supply unit connected to at least one inlet of each enclosure.

19. The method of claim 18, wherein supplying the coating fluid further comprises regulating the flow of coating fluid from the supply unit to the at least one enclosure using at least one valve.

20. The method of claim 19 further comprising facilitating removal of the excess coating fluid through at least one outlet of at least one enclosure using at least one valve.

21. The method of claim 20 further comprising collecting the excess coating fluid in a reservoir connected to each enclosure.
